(19) United States
(12) Patent Application Publication
(10) Pub. No.: US 2025/0102793 A1
(43) Pub. Date: Mar. 27, 2025

(54) METHODS OF DESIGNING OBJECTIVE LENS ARRANGEMENTS

(71) Applicant: Applied Materials Israel Ltd., Rehovot (IL)

(72) Inventor: Menachem LAPID, Hashmonaim (IL)

(21) Appl. No.: 18/896,780

(22) Filed: Sep. 25, 2024

(30) Foreign Application Priority Data
Sep. 26, 2023 (IL) 307263

(51) Int. Cl. G02B 27/00; G02B 21/02; G02B 21/06; G02B 21/36

(52) U.S. Cl. CPC G02B 27/0012; G02B 21/02; G02B 21/06; G02B 21/361

(57) ABSTRACT

The present disclosure relates to a method of designing an objective lens arrangement for an optical microscope system, said objective lens arrangement being configured, in use, to collect light from a plurality of field points on an object and to onwardly transmit a light beam formed from the collected light, the method comprising: (a) providing an objective lens; (b) tracing, for the plurality of field points, a light cone from each field point through said objective lens arrangement; (c) determining a marginal ray and a chief ray for said light cone from each field point exiting said objective lens arrangement and monitoring said marginal ray relative to said chief ray for each light cone exiting said objective lens arrangement; (d) determining an exit pupil contour for said objective lens arrangement respective of each field point and monitoring an overlap of exit pupil contours respective of said plurality of field points; (e) determining an exit pupil magnification with respect to an entrance pupil of said objective lens arrangement for each field point and monitoring a deviation in said exit pupil magnification respective of said plurality of field points; (f) adjusting one or more physical parameters of said objective lens arrangement; and (g) repeating one or more of (b) to (f) until said marginal ray relative to said chief ray for each light cone exiting said objective lens arrangement are substantially parallel, said overlapping is substantially maximised, and said deviation in said exit pupil magnification is substantially minimised.

### RELATED APPLICATIONS

This application claims the benefit of priority from Israeli Patent Application No. 307263, filed Sep. 26, 2023, which is incorporated herein by reference.

### TECHNOLOGICAL FIELD

The present technology relates to optical microscope systems and methods of designing such optical microscope systems, in particular objective used in such optical microscope systems. The present technology may be implemented in an optical inspection system comprising a reflective optical microscope system disclosed herein for inspecting a specimen or an object, for example, but not limited to, semiconductor wafer and/or mask inspection systems.

### BACKGROUND ART

There exist a variety of systems for use in inspections of specimens. These systems may include optical systems such as various microscopes (conventional and digital) and microscope arrangements, and the specimens may include any organic or inorganic specimens such as, amongst other things, semiconductor wafers and masks.

A conventional optical inspection system generally comprises an objective for collecting or receiving light from a specimen under inspection. The objective may comprise one or more objective lenses and, in an ideal case, form an image of the specimen at infinity. The objective may form a part of an objective lens arrangement that further comprises additional lenses such as a telescope to enable adjustment of the image magnification of the specimen. For example, an objective lens may be arranged to receive and focus light onto an intermediate focal plane, and the one or more additional lenses may be configured to relay the light from the intermediate focal plane to an exit pupil of the objective lens arrangement.

The specimen may be illuminated by a suitable light source, and the specimen reflects and/or scatters the light from the light source. Imaging the light collected from the specimen enables analyses of the surface (or internal) structure of the specimen. The specimen may be received and secured on a stationary platform or moved on a stage mechanism that allows the specimen to be moved in one dimension (e.g. varying a distance between the specimen and the objective lens or objective lens arrangement along a z-axis), two dimensions (e.g. along the z-axis and in a scan direction, x-axis or y-axis, orthogonal to the z-axis), or in three dimensions, as desired. The light source may be external to the optical inspection system or provided as an integral part of the optical inspection system as desired, and may include aerial illumination, a single point light source (e.g. a laser) or an array of point light sources, varying in wavelengths and intensities, as desired. The objective lens arrangement onwardly transmits the light (reflected, transmitted and/or scattered) collected from the specimen, then an imaging lens, disposed along the optical axis of and behind the objective lens arrangement, forms a magnified image of the specimen (or a part of the specimen) with the light from the objective lens arrangement onto an image plane, or back focal plane, of the imaging lens. The magnified image of the specimen (or part of the specimen) may then be detected using one of a variety of optical detector apparatus, including an optical detectors array e.g. of CCD detectors, photo diodes, or photomultipliers, etc. Herein, a “magnified image” may include both an enlarged image of a (or part of a) specimen, a reduced image (i.e. smaller than the specimen) or an image of the same scale as the specimen; in other words, a magnified image may have a magnification of >1, <1 or equal to 1.

In some implementations, it may be desirable to separate the light collected (by the objective lens arrangement) from a given part of a specimen into different portions. For example, in defect inspection, it may be desirable to separate the central or inner portion of the collected light from the peripheral or outer portion. In some implementations in which the specimen is illuminated from the center (i.e. substantially perpendicular to the specimen surface), the central portion generally corresponds to light directly reflected off the specimen surface (brightfield, BF) such that dark regions (in a light background) represent defects on the surface, while the peripheral portion corresponds to light scattered by the defects or particulates on the specimen surface (darkfield, DF) such that light regions (in a dark background) represent the defects. In other implementations, the specimen may be illuminated from the periphery (i.e. at an angle with the specimen surface), in which case the central portion of the collected light then generally corresponds to darkfield signal, while the peripheral portion of the collected light corresponds to brightfield signal. In such implementations, a variety of suitable devices may be used to separate the central portion of the collected light from the peripheral portion of the collected light, such as a coupling mirror.

For such optical systems with multiple lenses and more than one optical path, designing and positioning the various elements of a system can be challenging and therefore such systems are often not optimally designed and subsequently cannot be optimally calibrated. There is therefore scope to provide improved methods of designing an optical system.

### GENERAL DESCRIPTION

An aspect of the present technology provides a computer implemented method of designing an objective lens arrangement for an optical microscope system, said objective lens arrangement being configured, in use, to collect light from a plurality of field points on an object and to onwardly transmit a light beam formed from the collected light, the method comprising: (a) providing an objective lens (and, in some embodiments, optionally one or more additional optical element); (b) tracing, for the plurality of field points, a light cone from each field point through said objective lens arrangement; (c) determining a marginal ray and a chief ray for said light cone from each field point exiting said objective lens arrangement and monitoring said marginal ray relative to said chief ray for each light cone exiting said objective lens arrangement; (d) determining an exit pupil contour for said objective lens arrangement respective of each field point and monitoring an overlap of exit pupil contours respective of said plurality of field points; (e) determining an exit pupil (local) magnification with respect to an entrance pupil of said objective lens arrangement for each field point and monitoring a deviation in said exit pupil magnification respective of said plurality of field points; (f) adjusting one or more physical parameters of said objective lens arrangement; and (g) repeating one or more of (b) to (f) until said marginal ray relative to said chief ray for each light cone exiting said objective lens arrangement are substantially parallel, said overlapping is substantially maximised, and said deviation in said exit pupil magnification is substantially minimised. Herein, the term “exit pupil magnification” generally refers to local magnification. Herein, “axial positions” generally refer to positions along the optical axis of the objective lens arrangement, while “lateral positions” generally refer to positions on a plane orthogonal to the optical axis. It is noted that the term “providing an objective lens” as used herein may be understood as setting initial physical parameters (e.g. optical indices, lens surface curvatures, dimensions, number of optical elements in the objective lens arrangement, relative positions of the optical elements, lens shapes, production tolerances, alignment tolerances; etc.) of an objective lens arrangement in an initial design state. In other words, the initial design state is further refined until it satisfies a merit function formulated in order to jointly meet the requirements of limiting pupil wandering, limiting non-telecentricity at the wafer side and limiting pupil distortion. It should be noted that methods of the present technology may be (and preferably are) performed simultaneously, or substantially simultaneously, with performance optimization of the system as an imaging system e.g. for a semiconductor wafer or mask (from specimen to detectors) according to existing techniques.

According to embodiments of the present technology, an optical microscope system is designed by refining a set of parameters, including alignment, of one or more optical elements of the objective lens arrangement of the system, such that an image of the entrance pupil of the objective lens arrangement, formed behind the objective lens arrangement on the exit pupil plane, substantially overlap (laterally and axially) the exit pupil of the object lens arrangement. In general, to image the entrance pupil, light is traced from the entrance pupil to the exit pupil (point to point imaging). For example, a point illumination source at the entrance pupil is passed through the objective lens arrangement from the entrance pupil through the objective lens arrangement to the exit pupil. A calibration object, for example a mirror or a diffraction grating, may be positioned at the specimen plane to reflect or diffract light through the optical system towards the exit pupil to imitate the path(s) light from a specimen will travel in a real system. In examples of the present technology, computer simulation may be employed to simulate the objective lens arrangement and the light paths. In some embodiments, a pupil relay system may be provided (simulated) in front of the objective lens arrangement as part of the design process, such that a simulated light beam entering the objective lens arrangement comes from the preceding pupil relay system that images its entrance pupil onto the entrance pupil plane of the objective lens arrangement. During the design process, a light cone from each of a plurality of field points is traced through the objective lens arrangement, e.g. through generation of a computer simulation. A marginal ray and a chief or centroid ray for the light cone from each field point exiting the objective lens arrangement are determined, and the marginal ray relative to the chief ray for each light cone is monitored. Moreover, an exit pupil contour for the objective lens arrangement respective of each field point is determined, and an overlap of plural exit pupil contours respective of the plurality of field points is monitored. Further, an exit pupil (local) magnification with respect to an entrance pupil of the objective lens arrangement for each field point is determined, and a deviation in the exit pupil (local) magnification respective of the plurality of field points is monitored. Then, one or more physical parameters of the objective lens arrangement are adjusted to refine the design, and one or more of the determining, monitoring and adjusting steps are repeated until the marginal ray relative to the chief ray for each light cone are substantially parallel, the overlapping of exit pupil contours is substantially maximised, and the deviation in the exit pupil (local) magnification is substantially minimised. Through adjusting (refining) the parameters of the objective lens arrangement as described above, it is possible to optimise the design of an objective lens arrangement for optimal performance through, simultaneously or otherwise, reducing or minimising non-telecentricity, reducing or minimising pupil wandering, and reducing or minimising pupil distortion.

In some embodiments, said one or more physical parameters of said objective lens arrangement may comprise one or more of: an addition of one or more additional optical elements, a focal length of said objective lens and/or said one or more additional optical elements, a diameter of said objective lens and/or said one or more additional optical elements, an axial distance between said objective lens and said one or more additional optical elements, or a relative lateral position between said objective lens and said one or more additional optical elements.

In some embodiments, said objective lens arrangement comprises at least one additional optical element, and said one or more physical parameters of said objective lens arrangement may comprise an alignment of said objective lens arrangement, wherein adjusting said one or more physical parameters of said objective lens arrangement may comprise adjusting a relative position of said at least one additional optical element and said objective lens.

In some embodiments, the method may further comprise determining that said marginal ray relative to said chief ray for a given light cone exiting said objective lens arrangement are substantially parallel when a relative angle between said marginal ray and said chief ray for said given light cone is less than or equal to a predetermined lower angle limit.

In some embodiments, said predetermined lower angle limit may be 5°, 1°, 0.5°, or 0.1°, wherein 0° denotes parallel.

In some embodiments, the method may further comprise determining that said overlapping is substantially maximised when said overlapping of exit pupil contours respective of said plurality of field points is equal to or greater than a predetermined overlapping threshold.

In some embodiments, said overlapping of exit pupil contours respective of said plurality of field points may be represented as a percentage of overlap, and said predetermined overlapping threshold is 80%, 85%, 90%, 95%, 99%, 99.9%, 99.95%, wherein 100% denotes complete overlap.

In some embodiments, said exit pupil magnification for each field point may be a magnification of the exit pupil relative to the entrance pupil of said objective lens arrangement for that field point, and said deviation in said exit pupil magnification may be a deviation from a predetermined magnification for each of said plurality of field points. Herein, the term “exit pupil magnification” generally refers to local magnification. In general, distortion is assessed through mapping and treated based on local magnification changes.

In some embodiments, the method may further comprise determining that said deviation in said exit pupil magnification is substantially minimised when a percentage of deviation from said predetermined magnification is below 5%, below 2% or below 1%, wherein, optionally, said predetermined magnification is 1.

In some embodiments, the objective lens arrangement may be configured such that such that, for each field point of the plurality of field points on the object, the onwardly transmitted light beam formed from light collected from the field point exits the objective lens arrangement as parallel light rays imageable at infinity. In other words, the objective lens arrangement in such embodiments may be configured for telecentricity, or to be substantially telecentric, on the specimen (object) side.

In some embodiments, tracing, for the plurality of field points, a light cone from each field point through said objective lens arrangement may comprise generating a computer simulation of said objective lens arrangement, using as inputs said one or more physical parameters of said objective lens arrangement and one or more tolerances with respect to said objective lens.

In some embodiments, adjusting one or more physical parameters of said objective lens arrangement may comprise adjusting one or more physical parameters of said generated computer simulation of said objective lens arrangement and analysing a resulting simulation.

In some embodiments, the method may further comprise substantially simultaneously determining that said marginal ray relative to said chief ray for each light cone exiting said objective lens arrangement are substantially parallel, said overlapping is substantially maximised, and said deviation in said exit pupil magnification is substantially minimised based on wavefront error analysis.

Another aspect of the present technology provides a non-transitory computer-readable medium comprising machine-readable code which, when executed by a processor, causes the processor to perform the method as described above.

A further aspect of the present technology provides an objective lens arrangement for an optical microscope system designed according to the method as described above.

A yet further aspect of the present technology provides an inspection system for inspecting an object, comprising: an objective lens arrangement for an optical microscope system designed according to the method as described above; at least one imaging lens arrangement configured to receive light from said light signal separation unit to form an image; and at least one light detector apparatus configured to detect said image formed by said at least one imaging lens arrangement.

In some embodiments, the inspection system may further comprise an illumination source arranged to illuminate the object through the objective lens arrangement by forming a afocal beam at an illumination exit pupil.

In some embodiments, the inspection system may further comprise a coupling unit disposed on said imaging plane or said adjusted imaging plane, said coupling unit being configured to separate a peripheral portion of said onwardly transmitted light beam from said objective lens arrangement from a central portion of said onwardly transmitted light beam from said objective lens arrangement

In some embodiments, said at least one imaging lens arrangement may comprise a first imaging lens arrangement configured to receive said peripheral portion of said onwardly transmitted light beam from said objective lens arrangement to form a first image, and a second imaging lens arrangement configured to receive said central portion of said onwardly transmitted light beam from said objective lens arrangement to form a second image.

In some embodiments, the at least one light detector apparatus comprises a first light detector apparatus configured to detect the first image from the first imaging lens arrangement and a second light detector apparatus configured to detect the second image from the second imaging lens arrangement.

In some embodiments, the inspection system may be a semiconductor wafer and/or mask inspection system.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows schematically an exemplary inspection system for inspecting a specimen;

FIG. 2 shows schematically another exemplary inspection system for inspecting a specimen;

FIG. 3 shows schematically simulated light rays entering and exiting an exemplary objective lens arrangement;

FIG. 4 shows an exemplary simulated optical system comprising an objective lens arrangement;

FIG. 5 shows a simulated optical system comprising an objective lens arrangement and a pupil relay module on the object side;

FIG. 6 shows the same optical system as in FIG. 5;

FIG. 7 illustrates an effect of beam deformation along the optical axis;

FIG. 8 illustrates an exemplary determination of an axial position for positioning a light signal separation unit;

FIG. 9 shows a flow diagram of an exemplary method of designing an optical microscope system; and

FIG. 10 shows schematically an alternative exemplary inspection system.

### DETAILED DESCRIPTION OF EMBODIMENTS

In optical systems, factors such as design variations, alignment variations, aberrations, etc. in various optical elements may impact on the performance of a system. For example, for an objective lens arrangement that comprises a plurality of elements, for example (but not limited to) an objective lens and a telescope, sub-optimal design, alignment and aberrations in the various elements can lead to non-telecentricity, wherein the image of the entrance pupil (located at the exit pupil) of the objective lens arrangement is slightly displaced axially from the entrance pupil of the objective lens arrangement (and/or the back focal plane of the objective lens arrangement and/or the exit pupil of the illumination system). Non-telecentricity can also result in a variety of higher-order aberrations that could interfere with the performance of the objective lens arrangement, which would also be advantageous to take into consideration. Moreover, pupil wandering (or pupil walking) is an observed lateral displacement of a light beam formed of light reflected off different field points on a specimen that is collected by the objective lens arrangement, such that the position of the exit pupil of the objective lens arrangement changes as observed along different points in the field of view. As such, some lateral displacement in the position of an exit pupil for a light beam exiting the objective lens arrangement may be observed with respect to the optical axis for light beams originating from different field points. Pupil distortion can also occur in sub-optimal designs, where the magnification of the image of the entrance pupil at the exit pupil plane of the objective lens arrangement deviate from a preferred magnification, and such deviation can vary for different field point as a result of sub-optimal design, which can impact on the magnification of the image when the system is in use. Herein, magnification in relation to pupil distortion generally refers to local magnification. In general, distortion is assessed through mapping and treated based on local magnification changes.

The three issues described above, namely non-telecentricity, pupil wandering and pupil distortion, leads to three main considerations when designing an optical system, which are (1) reducing or minimizing non-telecentricity; (2) reducing or minimizing the amount of pupil wandering; and (3) reducing or minimizing pupil distortion. In systems with high numerical apertures (NA), or high resolving power, in which the objective lens arrangement is capable of receiving light at a wide angle, these design considerations can be even more challenging, as refinement of the design (e.g. alignment) must take the full range of angles at which light can enter the objective lens arrangement into account. Conventionally, the three design considerations are treated separately and independently, and in many cases, design refinement is only performed to minimize non-telecentricity on the specimen side, e.g. by changing the position of the telescope in the objective lens arrangement until the expected position of the image of the entrance pupil matches the position of the exit pupil of the objective lens arrangement. As optimizing based on one consideration can impact on another aspect of the system, the design of the system is often not optimized for all three considerations and therefore the resulting system cannot perform optimally on all planes simultaneously (e.g. object plane, image plane and exit pupil plane).

Embodiments of the present technology provides methods for designing optical microscope systems such as optical reflective microscope systems. Such a system generally comprises an objective lens arrangement which typically includes an objective lens and one or more additional optical elements. The present approach is of particular relevance to systems with high numerical apertures (NA), in which the systems must be adapted for a wide range of incident angles.

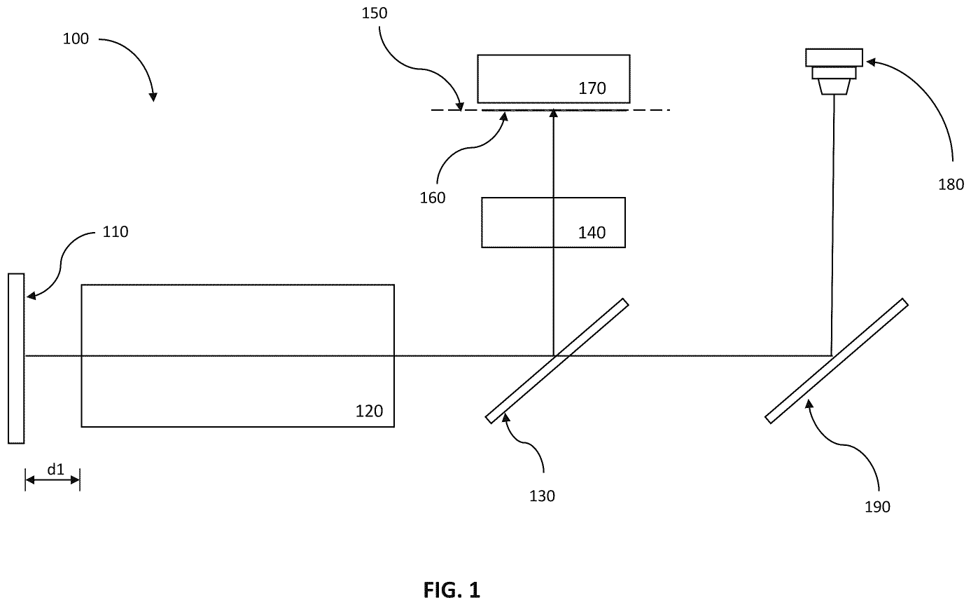

FIG. 1 shows schematically an exemplary inspection system 100 for inspecting a specimen according to an embodiment, for example (but not limited to) for inspecting defects, particles and/or patterns on the surface of a semiconductor wafer and/or mask as part of a quality assurance process in semiconductor manufacturing processes.

The Inspection system 100 comprises a set of optics or an optical system, which, in the present embodiment, includes an objective lens or objective lens arrangement 120 and an imaging lens or imaging lens arrangement 140. A light detector or light detectors array 170 is disposed behind the imaging lens or imaging lens arrangement 140 for detecting an image formed by the imaging lens or imaging lens arrangement 140. The detector or detectors array 170 may be a camera, a photomultiplier array or any other suitable light detectors. The inspection system 100 also comprises a platform 110 for receiving or securing an object or specimen for inspection. The platform 110 may be stationary or it may be a stage mechanism movable in a longitudinal direction (along the optical axis of the objective lens or objective lens arrangement 120, z-axis) and/or in a transverse direction (x- and/or y-axis) in the same plane as the platform 110. It should be understood that relative movements between the object or specimen may also be achieved by maintaining the platform 110 stationary while providing mechanism for moving the objective lens or objective lens arrangement 120 to change the relative position between the objective lens or objective lens arrangement 120 and the platform 110, or for moving all remaining elements of the inspection system 100 as a whole. For example, a stage mechanism may be configured to move in coordination with a scanning sequence to enable an object placed on the platform 110 to be scanned by a light source 180. The light source 180 may be aerial illumination, a single laser that functions as a point light source focused as a spot onto the object or an array of lasers.

In the present embodiment, a reflector 190 may be placed along the optical axis of the objective lens or objective lens arrangement 120 to direct the light beam from the light source 180 (through the objective lens or objective lens arrangement 120) towards the platform 110. This enables the light source 180 to be placed off the optical axis of the objective lens or objective lens arrangement 120, for example to achieve a more compact instrument. Similarly, the imaging lens or imaging lens arrangement 140 and the detector or detectors array 170 may also be arranged off the optical axis of the objective lens or objective lens arrangement 120 to e.g. achieve compactness, through the use of a partially reflective element 130. The element 130 may also function as a beam splitter arranged to allow a portion of the light from the object to pass through to the imaging lens or imaging lens arrangement 140 and direct another portion of the light in a different direction, e.g. towards a separate set of imaging lens arrangement and detectors. It should be understood that positioning the imaging lens or imaging lens arrangement 140 and the detector or detectors array 170 and/or the light source 180 at an angle with respect to the optical axis of the objective lens or objective lens arrangement 120 is entirely optional and not essential to the present technology.

The objective lens or objective lens arrangement 120 is arranged to collect light from the object (e.g. light from the light source 180 reflected and/or scattered off a portion of the object, or transmitted through a portion of the object as in the case of a transmission microscope). In some embodiments, the objective lens or objective lens arrangement 120 may optionally be configured for telecentric imaging at the object side such that light exits the objective lens or objective lens arrangement 120, and passes through an exit pupil (not shown) of the objective lens or objective lens arrangement 120, as parallel rays. Optionally, the objective lens or objective lens arrangement 120 may be configured such that the exit pupil is located at a position external to (at the back focal plane of) the objective lens or objective lens arrangement 120, if desired. In such embodiments, the partially reflective element 130 may optionally be disposed at the external exit pupil though it is not essential. In the present embodiment, the imaging lens 140 receives the light from the objective lens or objective lens arrangement 120 and forms an image onto the detector or detectors array 170 disposed on a target plane 150, and the detector or detectors array 170 detects an image formed thereon. In the present embodiment, it is desirable for any image formed by the imaging lens 140 to be confined within an effective imaging area of the light detector 170; as such, the effective imaging area of the light detector 170 defines a target region 160 within which the image is preferably confined.

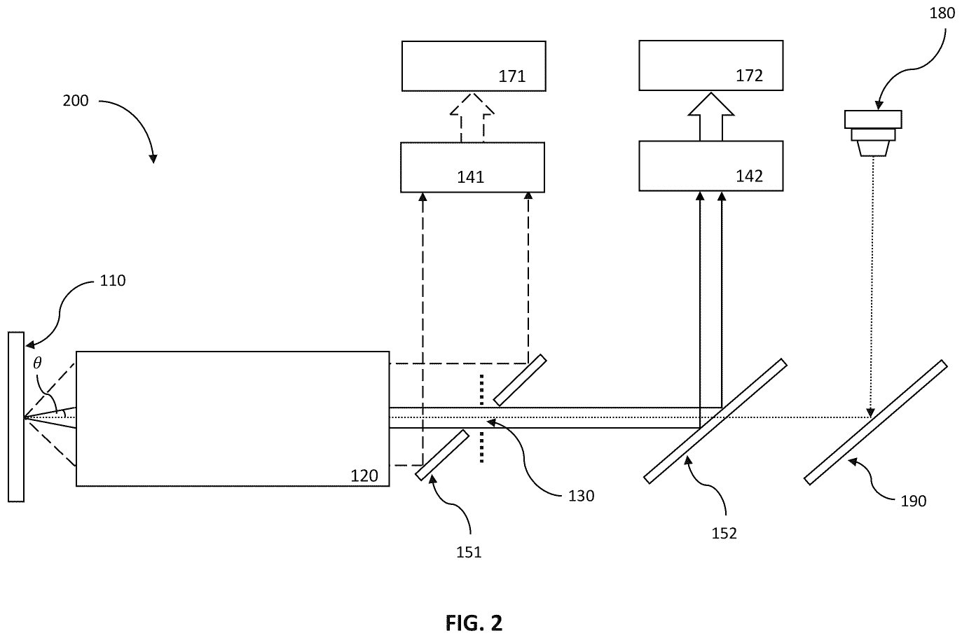

FIG. 2 shows schematically another exemplary inspection system 200 for inspecting a specimen according to an embodiment. For example, the inspection system 200 may be (but not limited to) a semiconductor wafer or mask inspection system for inspecting defects, particles and/or patterns on the surface of a semiconductor wafer as part of a quality assurance process in semiconductor manufacturing processes.

In the present embodiment, the inspection system 200 comprises a set of optical elements or, collectively, an optical system, which comprises at least an objective lens arrangement 120, and may further comprises other optical elements. In the present embodiment, the optical system further comprises two imaging lenses or imaging lens arrangements 141, 142 for imaging two types of light signal; however, this needs not be the case and fewer or more imagine lenses or imaging lens arrangements, as well as other optical elements, may be provided as desired, depending of the type and the number of types of signal. In the present embodiment, the objective lens arrangement 120 is configured (e.g. aligned) such that an exit pupil 130 thereof is relayed to a position external (instead of internal) to the objective lens arrangement 120, for example (but not limited to) by providing a pupil relay module (e.g. a telescope) behind one or more of the objective arrangement lenses. Two light detectors apparatuses 171 and 172 are each respectively disposed behind the two imaging lenses or imaging lens arrangements 141, 142 for detecting an image formed by the imaging lenses or imaging lens arrangements 141, 142. The detectors arrays 171, 172 may for example comprise a camera or a photomultiplier array, or any other suitable optical detector. The inspection system 100 also comprises a platform 110 for receiving or securing an object or specimen for inspection. The platform 110 may be stationary or it may be a stage mechanism movable in a longitudinal direction (along the optical axis of the objective lens or objective lens arrangement 120, or z-axis) and/or in a transverse direction (x- and/or y-axis) in the same plane as the platform 110. A light source or illumination source 180 is provided to the inspection system 100 for illuminating the object placed on the platform 110. For example, a stage mechanism may be configured to move in coordination with a scanning sequence to enable an object placed on the platform 110 to be scanned by the light source 180. The light source 180 may be a single point source (e.g. a laser) that illuminates a single point on the object or it may be an array of point sources that illuminates multiple points on the object simultaneously (thus capable of collecting information from multiple locations on the object simultaneously) or it may be an aerial illumination source which illuminates a continuous area.

A reflector 190 may be, and in the present embodiment is, placed along the optical axis of the objective lens arrangement 120 to direct a light beam or multiple light beams from the light source 180 (through the objective lens arrangement 120) towards the platform 110. This enables the light source 180 to be placed off the optical axis of the objective lens arrangement 120, for example to increase the compactness of the instrument. The illumination system comprised of the light source 180 and reflector 190 may form an afocal beam at an exit pupil thereof.

Each set of imaging lens/imaging lens arrangement 141, 142 and its corresponding light detector apparatus 171, 172, according to the present embodiment, is arranged to detect a different portion of the light collected by the objective lens arrangement 120. In particular, for the present embodiment, the detector apparatus 171 is configured to detect darkfield (DF) signal that is light scattered by uneven features, such as defects and/or particles, on the surface of the object, while the detector apparatus 172 is configured to detect brightfield (BF) signal that is light reflected off the surface of the object, in which case uneven features of the surface of the object appear as dark features against a light background. Light reflected off a point on the object may be regarded as forming a cone originating from that point with a chief ray or a centroid ray perpendicular to the surface of the object being the central axis of the cone. Such a light cone can be characterized by a half angle θ defined with respect to the central axis. Then, any light that is outside of the cone, i.e. coming off a point on the object at an angle greater than 0 with respect to the chief ray, may be regarded as scattered light which does not contain BF light or specular rays, hence can be detected with high SNR. For the present embodiment, since detection of separate DF and BF signals is desired, a unit 151 (e.g. coupling mirror/reflector, coupling module) may be provided to separate DF signal from BF signal, which can be disposed at a suitable position behind the objective lens arrangement 120. In an example, the unit 151 may be provided in the form of a mirror/reflector (e.g. a plane mirror) having formed therein an opening or transmissive region (e.g. an uncoated region of the mirror/reflector) substantially in the centre. The unit 151 is arranged to allow therethrough the central portion of a light beam from the objective lens arrangement 120, which comprises light reflected off the surface of the object within the angle θ, while the peripheral portion of the light beam, which comprises light scattered off at an angle greater than 0, is collected and reflected in a different direction by the reflective surface.

In the present embodiment, the coupling unit 151 is disposed at an angle (i.e. tilted) with respect to the optical axis of the objective lens arrangement 120, such that the peripheral portion of the light (DF signal) is directed off the illumination optical axis, enabling the imaging lens/imaging lens arrangement 141 and the detectors apparatus 171 to be arranged off the optical axis. Similarly, the imaging lens/imaging lens arrangement 142 and the corresponding detector apparatus 172 may also be, and in the present embodiment are, arranged off the optical axis of the objective lens arrangement 120 through the use of e.g. a partially reflective element 152 that is transmissive on one side to allow transmission of light from the light source 180 while reflective on the opposite side to reflect BF signal towards the BF detectors array 172. It should be understood that provision of the unit 151 to separate DF signal from BF signal and the provision of two imaging lenses or imaging lens arrangement 141, 142 with corresponding detector apparatuses 171, 172 are optional and not essential to the present technology. It should be further understood that positioning the imaging lenses or imaging lens arrangements 141, 142 and the detector apparatuses 171, 172 and/or the light source 180 at an angle with respect to the optical axis of the objective lens or objective lens arrangement 120 is optional and not essential to the present technology.

The objective lens arrangement 120 is arranged to receive and collect light reflected from a plurality of field points on the object (e.g. light from the light source 180 reflected and/or scattered off a portion of the object, or transmitted through a portion of the object as in the case of a transmission microscope). For optimal performance, the objective lens arrangement 120 is preferably configured for telecentric imaging at the object side. In particular, the objective lens arrangement 120 is, or elements of the objective lens arrangement 120 are, preferably arranged and aligned such that light collected from any given field point on the object by the objective lens arrangement 120 exits the objective lens arrangement 120, passing through an exit pupil 130 (illustrated as two dotted lines in FIG. 1), as parallel rays that is imaged at infinity. Moreover, in embodiments where the unit 151 is used to separate DF signal from BF signal, the unit 152 is ideally disposed at the exit pupil 130 and preferably arranged such that the central opening or transmissive region of the light signal separator/divider 151 coincides substantially with the exit pupil 130, laterally and axially, for optimal performance. In theory, for optimal performance, the system should be designed such that an image of the entrance pupil of the objective lens arrangement coincides (matches the position of) the exit pupil of the objective lens arrangement on the back focal plane of the objective lens arrangement. However, because of sub-optimal design such as errors in alignment of the optical elements of the objective lens arrangement and/or geometric aberration or distortion in pupil imaging, the image of the entrance pupil (ideally at the exit pupil) of the objective lens arrangement may be displaced from the exit pupil of the objective lens arrangement and/or the back focal plane of the objective lens arrangement. This may lead to BF signal becoming more dispersed (covering a larger diameter) and reducing the available area for collecting DF signal, which can significantly impact the total amount of DF signal available for collection and detection.

There may be further contributing factors that can impact the amount of DF signal that can be collected. For example, in an ideal arrangement, if the optics of the objective lens arrangement 120 are properly designed and set up with good alignment with minimal geometric aberration in pupil imaging, it may be possible that light received and collected by the objective lens arrangement 120 from every field point on a specimen would pass through the exit pupil 130 with minimal beam deformation and/or pupil wandering. However, in practice, a certain amount of alignment tolerances and geometric aberration is expected, such that beam deformation and lateral displacement of the exit pupil to varying extent are expected to be observed in a light beam exiting the objective lens arrangement 120 formed from light collected from different field points on the specimen. The extent of beam deformation and lateral displacement of the exit pupil, or pupil wandering, may be dependent on alignment tolerances of elements of the objective lens arrangement 120 as well as geometric imperfections of the lenses or optical instruments involved arising e.g. from the production process or the optical design of the objective lens arrangement.

In order to optimize the performance of an optical system, it is desirable to design an objective lens arrangement for minimal non-telecentricity on the object side such that a light beam exiting the objective lens arrangement exits as parallel rays and imageable at infinity. It is further desirable to minimize pupil wandering by designing the objective lens arrangement such that light transmitted by the objective lens arrangement may be collected (e.g. by a coupling mirror) at the exit pupil position (on the back focal plane) of the objective lens arrangement with minimal effect of beam deformation and/or lateral displacement of a light beam exiting the objective lens arrangement substantially minimal. Moreover, the minimization of non-telecentricity and the minimization of pupil wandering is preferably performed substantially in parallel, since adjusting one generally has an impact on the other.

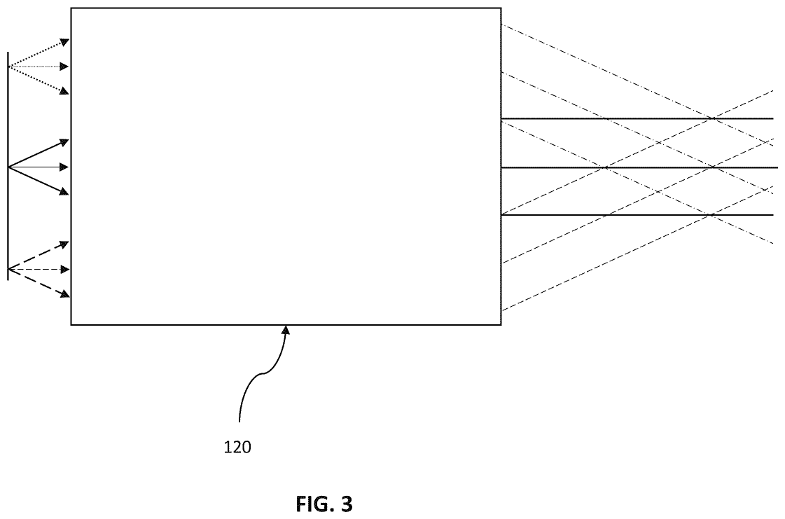

FIG. 3 schematically illustrates simulated light rays entering and exiting the objective lens arrangement 120 from different field points. In an ideal arrangement, a light cone from the central field point (along the optical axis of the objective lens arrangement 120) entering the objective lens arrangement 120 would exit the objective lens arrangement 120 as parallel rays parallel to the optical axis of the objective lens arrangement 120. Light cones from other field points, in such ideal arrangement, would exit the objective lens arrangement 120 as parallel rays parallel to the respective chief or centroid ray. The respective sets of parallel rays exiting the objective lens arrangement 120 ideally coincide laterally and axially within an area that is the exit pupil of the objective lens arrangement 120.

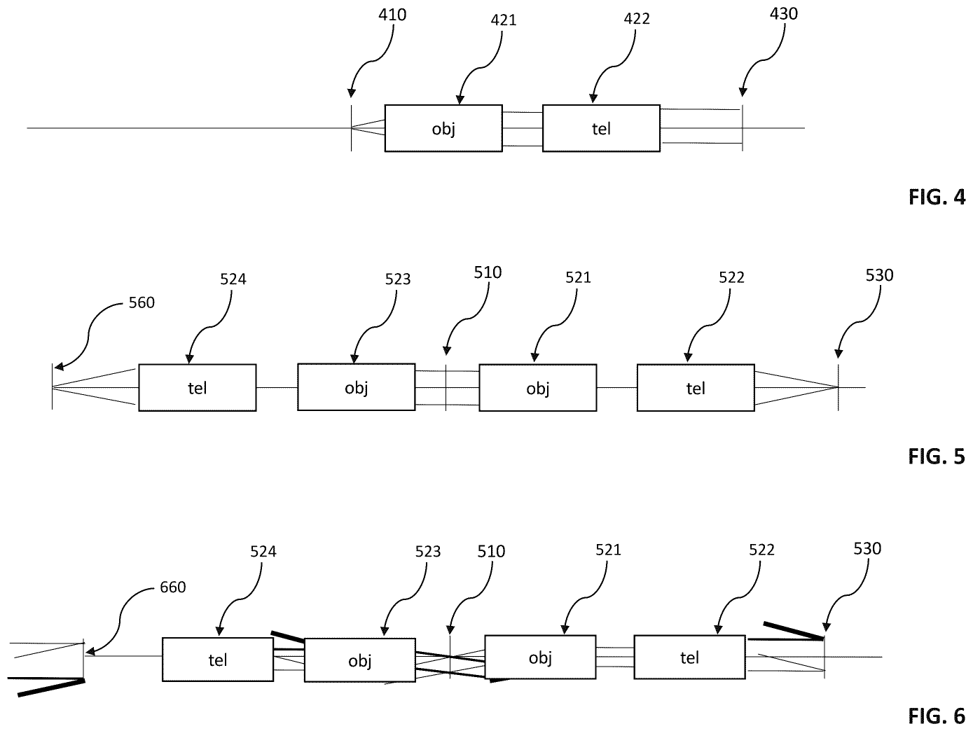

FIG. 4 shows a simulation of an exemplary optical system comprising an objective lens arrangement. In the present embodiment, the objective lens arrangement comprises an objective lens 421 and telescope 422 (comprising one or more optical elements). In other embodiments, the objective lens arrangement may comprise additional lenses and/or other optical elements. An object (e.g. calibration object such as a reflector/mirror, a specimen to be inspected such as a wafer, etc.) 410 is positioned substantially at the entrance pupil of the objective lens arrangement. As can be seen in FIG. 4, when the objective lens 421 and the telescope 422 (and any other optical elements) are optimally aligned, light collected from the object 210 by and transmitted through the objective lens arrangement exits the objective lens arrangement as parallel rays through the back focal plane 430. An example illustrating an objective lens arrangement for substantially minimizing pupil wandering is illustrated by FIGS. 5 and 6.

FIG. 5 shows a simulated optical system comprising an objective lens arrangement provided with a pupil relay module on the object side. The optical system comprises an objective lens 521 and telescope (comprising one or more optical elements) 522 forming the objective lens arrangement, and an additional objective lens 523 and additional telescope (comprising one or more optical elements) 524 forming the pupil relay module. Reference numeral 510 denotes the position at which a specimen for inspection would be placed when the objective lens arrangement is in use. The present embodiment may be used for designing an optical system optimized for BF signal by placing (e.g. in a simulated system) a calibration object 560 such as a reflector or mirror in front of the telescope 524 at a position substantially coincide with the exit pupil of the pupil relay module. For BF signal (directly reflected light from an object), the optical system is ideally designed by optimizing the parameters of (e.g. aligning the relative position of) the objective lenses 521, 523 and telescope 522, 524 such that the image of the entrance pupil substantially overlaps the exit pupil of the objective lens arrangement on the back focal plane 530.

FIG. 6 shows the same optical system as in FIG. 5, which again comprises the objective lens 521 and telescope 522 forming the objective lens arrangement, and the additional objective lens 523 and additional telescope 524 forming the pupil relay module. Reference numeral 510 again denotes the position at which a specimen for inspection would be placed when the objective lens arrangement is in use. FIG. 6 shows the use of the present embodiment in the designing of an optical system optimized for DF signal by placing (e.g. in a simulated system) a calibration object 660 such as a diffraction grating in front of the telescope 524 at a position substantially coincide with the exit pupil of the pupil relay module. The calibration object 660 is configured to scatter light from an illumination source (e.g. transmitted through the optical system) to mimic DF signal from an inspection specimen. The design of the optical system is then refined by optimizing the parameters of (e.g. aligning the relative position of) the objective lenses 521, 323 and telescope 522, 524 such that light scattered off the calibration object 460 collected by the optical system and transmitted through the objective lens arrangement forms an image that substantially overlaps the exit pupil of the objective lens arrangement on the back focal plane 530.

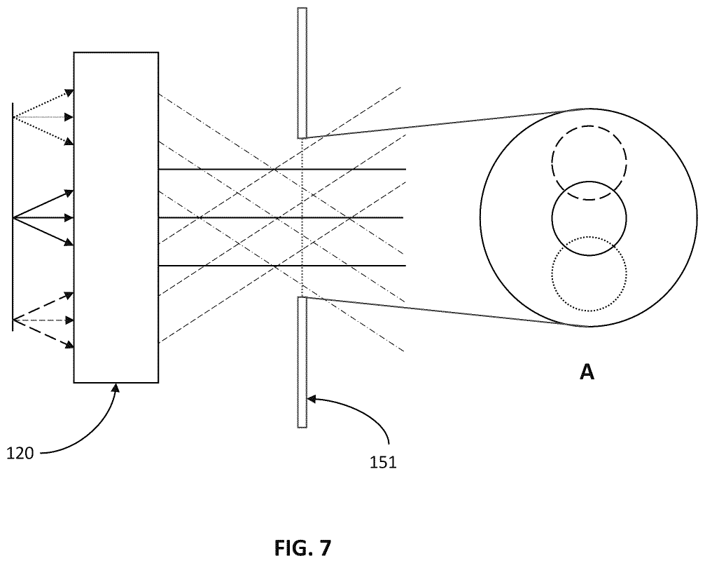

FIG. 7 illustrates an example in which alignment error and/or production imperfections resulting, for example, from variations in optical designs cause beam deformation and some lateral displacement of the position of light beams formed from light reflected off different field points on the object surface (also known as pupil wandering). In FIG. 7, the effect of beam deformation and lateral displacement is exaggerated for the purpose of illustration only. In practice, such lateral deviations or variations is generally in the range of a few percent. The effect of beam deformation and lateral displacement may be observed by placing (e.g. in a simulated system) e.g. a screen at different axial positions along the optical axis and observe the shape and position of a simulated illuminated area formed thereon. As shown in FIG. 7, if a coupling mirror 151 is placed at an axial position at which the effect of beam deformation and/or lateral displacement is large, the position of the central portion of a light beam (e.g. BF signal) collected from different field points on the object and transmitted through the objective lens arrangement 120 becomes more dispersed, then in order to allow through the central portion of the light beam from different field points, a large central transmissive region would be required; however, doing so reduces the amount of the peripheral portion of the light beam (e.g. DF signal) available for collection.

In order to maximize the amount of the peripheral portion of a light beam available for collection, it is desirable to determine an axial position at which the effect of beam deformation and/or lateral displacement is less or minimal during the design process, so as to collect the light transmitted through the objective lens arrangement 120 at that axial position, e.g. by disposing the coupling mirror at this axial position.

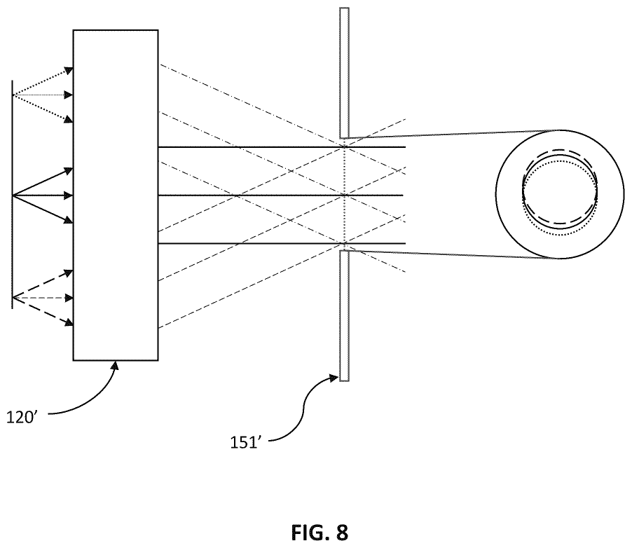

As illustrated in FIG. 8, at an axial position at which the effect of beam deformation and/or lateral displacement is minimal, the position of the central portion of a light beam collected from different filed points on the objected and transmitted through the objective lens arrangement 120′ is clustered around or at the exit pupil of the objective lens arrangement 120′, and pupil wandering is minimized. In examples where a coupling mirror is used, the dimension of the central transmissive region of a coupling mirror 151′ can be minimized such that a larger area of the coupling mirror 151′ becomes available for collecting the peripheral portion of the light beam (e.g. DF signal).

In some embodiments, it may be desirable to optimize the design of one or more optical elements of the optical system and the optical system as a whole, in particular, elements of the objective lens arrangement 120, with respect to pupil distortion simultaneously with minimizing pupil wandering. For example, for an objective lens arrangement that comprises a plurality of optical elements, such as (but not limited to) an objective lens and a telescope, the design of (e.g. the parameters of) the objective lens arrangement may be refined to optimize or otherwise improve the consistency of exit pupil (local) magnification of the objective lens arrangement with respect to a plurality of field points. For example, the parameters of various elements of the objective lens arrangement may be refined such that the exit pupil (local) magnification with respect to most or all of the field points is substantially 1, or that the deviation of the exit pupil (local) magnification with respect to most or all of the field points from a predetermined (local) magnification (e.g. 1) is less than a certain percentage, e.g. 5%, 2%, 1%, etc. In other embodiments, it may be desirable to optimize the design of one or more optical elements of the optical system by minimizing pupil distortion and pupil wandering substantially at the same time as minimizing non-telecentricity, since all three optimizations are inter-dependent, such that when the design is substantially optimized, all three design considerations have been taken into account.

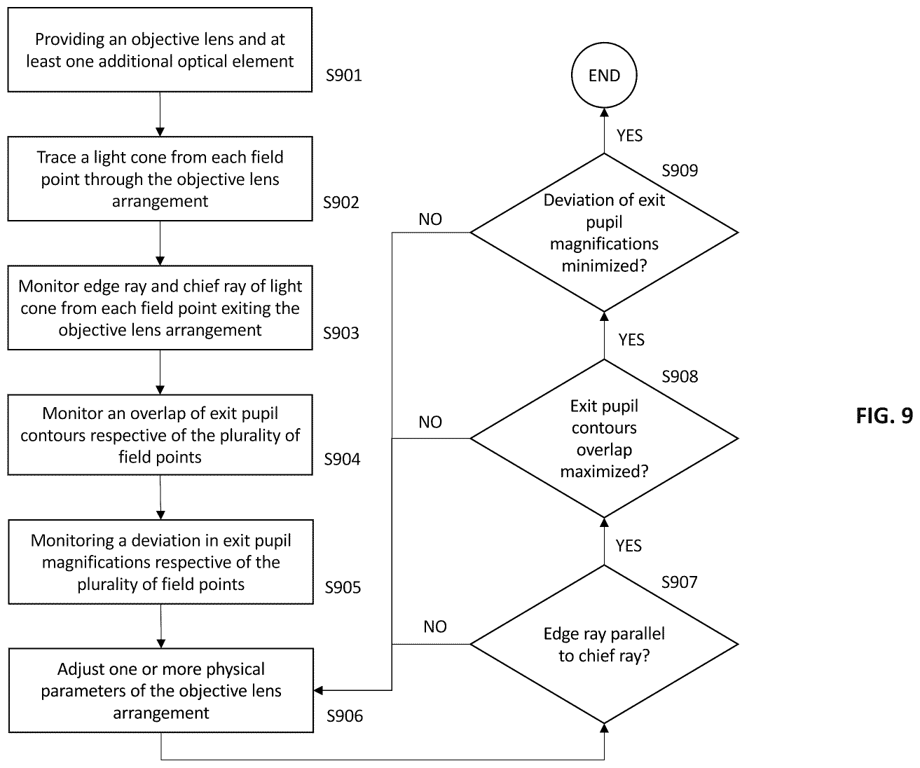

FIG. 9 shows a flow diagram of an exemplary method of designing an optical microscope system, such as the optical system shown in FIGS. 1 and 2. In the present embodiment, the optical microscope system to be designed comprises an objective lens arrangement having an objective lens and optionally one additional optical element (e.g. a telescope). The objective lens arrangement is configured, in use, to collect light from a plurality of field points on an object and to onwardly transmit a light beam formed from the collected light.

The method begins at S901 by providing an objective lens and an optional additional optical element (e.g. one or more lenses and/or elements forming a telescope). This may be performed in a computer simulation in which physical parameters and any tolerances for each of the physical parameters may be use as input to generate a computer simulation of the objective lens and the optional additional optical element.

Then, at S902, for the plurality of field points on a simulated object (e.g. a calibration object), a light cone from each field point is traced through the objective lens arrangement to measure or otherwise determine the effect of the objective lens arrangement on each light cone.

Thus, at S903, a marginal ray and a chief ray of a light cone exiting the objective lens arrangement are determined for each field point, and the marginal ray relative to the chief ray for each light cone exiting the objective lens arrangement are monitored to measure an extent of telecentricity.

Moreover, at S904, the contour (outline, border) of an exit pupil for the objective lens arrangement respective of each field point is determined, and an overlap of plural exit pupil contours respective of the plurality of field points is monitored to measure an extent of pupil wandering.

Further, at S905, a deviation from a predetermined (or designed) local magnification for exit pupil magnifications (a local magnification of an exit pupil relative to a corresponding entrance pupil of the objective lens arrangement) respective of the plurality of field points is monitored to measure an extent of pupil distortion.

Then, at S906, one or more physical parameters of the objective lens arrangement are adjusted, e.g. in the computer simulation of the objective lens arrangement to refine the design of the objective lens arrangement.

The adjustment of the one or more physical parameters of the objective lens arrangement is repeated (steps S907, S908, S909, NO branch) until it is determined that the marginal ray relative to the chief ray for each light cone (or at least a proportion of light cones) exiting the objective lens arrangement are substantially parallel (step S907, YES branch), and it is determined that the overlap of exit pupil contours is substantially maximised (step S908, YES branch), and it is determined that the deviation of exit pupil magnifications is substantially minimized (step S909, YES branch), such that the design of the objective lens arrangement is satisfactorily optimised, then the process ends.

In some embodiments, the one or more physical parameters of the objective lens arrangement may for example include a focal length of the objective lens and/or the optional additional optical element, a diameter of the objective lens and/or the optional additional optical element, a curvature (spherical or aspherical, or free from curvature) or geometry of the objective lens and/or the optional additional optical element (that changes the curvature of the wavefront exiting the objective lens arrangement), an alignment of the objective lens arrangement such as an axial distance or relative lateral position between the objective lens and the optional additional optical element, an addition of one or more further optical elements, and any other parameters related to the objective lens arrangement and its elements that may impact or alter the optical properties of the objective lens arrangement. Other factors such as the temperature and/or the atmospheric pressure of the system may also impact the overall optical properties or optical performance of the objective lens arrangement. The effect(s) of a change in one or more physical parameters of the objective lens arrangement may, for example, be observed in the (simulated) shape of the exiting wavefront map of the pupil imaging system of the objective, the (simulated) lateral and axial position of the entrance pupil and/or exit pupil of the objective lens arrangement, etc.

For example, it may be determined that the marginal ray relative to the chief ray for a given light cone exiting the objective lens arrangement are substantially parallel when a relative angle between the marginal ray and the chief ray for the given light cone is less than or equal to a predetermined lower angle limit. The predetermined lower angle limit may for example be 5°, 1°, 0.5°, or 0.1°, wherein 0° denotes parallel.

For example, it may be determined that the overlap of exit pupil contours is substantially maximised when the overlap of exit pupil contours respective of the plurality of field points is equal to or greater than a predetermined overlap threshold. For example, the overlap of exit pupil contours respective of the plurality of field points may be represented as a percentage of overlap, and the predetermined overlap threshold may be 80%, 85%, 90%, 95%, 99%, 99.9%, 99.95%, wherein 100% denotes a complete overlap.

Pupil distortion may be determined based on the non-uniformity of light gathered at the exit pupil of an optical system in comparison with a uniformly illuminated exit pupil. Through mapping for each position within the exit pupil the ratio of a difference between the maximum deviation and the minimum deviation and the average deviation with respect to that point ([max-min]/average), it is possible to gain an understanding of the expected performance. The extent of distortion caused by an optical system may be measured as a percentage of deviation between the position of the in-situ (actual) beam exiting the optical system and the expected paraxial beam position. In a simulation, the local magnification of an exit pupil may be determined for each field point relative to the corresponding entrance pupil of the objective lens arrangement/optical system. The deviation of each exit pupil local magnification from a predetermined or preferred local magnification with respect to each field point may be monitored to gauge the extent of pupil distortion. The design of the objective lens arrangement may be refined by minimising pupil distortion. For example, it may be determined that pupil distortion is substantially minimized when the percentage of deviation from the predetermined or preferred magnification (e.g. 1) is e.g. less than 10%, 5%, 1%, etc., with 0% being no deviation and therefore no pupil distortion.

It should be noted that steps S903, S904 and S905 may be performed substantially simultaneously. Further, it should be noted that steps S907, S908 and S909 may be performed substantially simultaneously. By performing the calibration method of FIG. 9, it is possible to simultaneously, or near simultaneously, minimize non-telecentricity and pupil wandering for optimal performance.

The (pupil) imaging performance of an optical system has an impact on the detection and noise filtering of an instrument (e.g. an optical microscope, a semiconductor wafer/mask inspection instrument, etc.) that uses the optical system. In essence, the present technology sets forth methods for designing optical systems (e.g. pupil imaging systems) that satisfy a requirement of reducing or minimising wavefront aberrations.

How much aberration is acceptable in an optical system may vary depending on applications. For example, for a semiconductor inspection instrument, the detection physics and detection scheme on a semiconductor wafer may translate into a specific acceptable range of one or more seidel aberrations in the optical system used in the instrument. Such specific requirements may, for example, include local centroid ray angle changes e.g. in terms of a tilt in the (lateral) x- and/or y-direction, a magnification power along the x- and/or y-axis, as described above, and additionally spherical aberration, coma aberration and/or higher order aberrations, each of which can result in local changes in the angle of the centroid of a ray, may also be considered and translated into design requirements or specification.

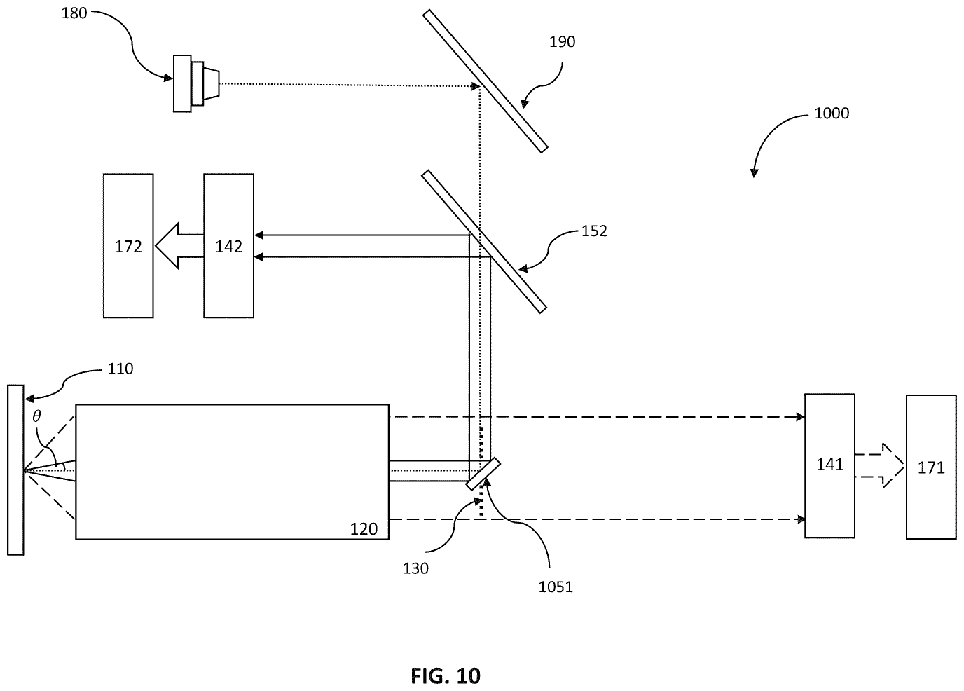

Alternative embodiments of light signal separation units have been contemplated, as shown in FIG. 10. In an alternative embodiment, an inspection system 1000 is provided for inspecting a specimen. Herein, like reference numerals refer to like parts or elements throughout the description, and detailed description of these parts and elements will not be repeated below.

In the present embodiment, the GF detector apparatus 171 and the corresponding imaging lens 141 are arranged along the optical axis of the objective lens arrangement 120. Thus, in this embodiment, in order for the imaging lens 141 and therefore detector apparatus 171 to receive GF signal (the peripheral portion of the light beam), an alternative embodiment to the unit 151, the coupling unit 851, is provided, which comprises a central reflective region surrounded by a peripheral transmissive region. In some embodiments, the central reflective region may be a reflective coating and the peripheral transmissive region may be an uncoated region. In some embodiments, the central reflective region may be a plane mirror and the peripheral transmissive region may simply be an absence of the mirror.

In order to collect BF signal (the central portion of the light beam), the light signal separation unit 1051 is arranged, again, proximal to the exit pupil 130 of the objective lens arrangement 120, and at an angle to the optical axis of the objective lens arrangement 120. In doing so, BF signal is reflected off the central reflective region of the light signal separation unit 851, for example at substantially right angle, and optionally towards a reflector 152 that reflects the BF signal towards the imaging lens 142 and the corresponding BF detector apparatus 172.

Optionally, as is shown in FIG. 10, the light source 180 may also be arranged in a similar spatial arrangement to the imaging lens 142 and the corresponding BF detector apparatus 172, such that illumination from the light source 180 travels towards a reflector 190 through the transmissive side of the reflector 152 and towards the central reflective region of the light signal separation unit 851. The central reflective region of the light signal separation unit 851 then reflects the illumination towards the platform 110 through the objective lens arrangement 120.

It should be emphasized that the design methods described herein aim to offer simultaneous or substantially simultaneous optimisation for telecentricity at the specimen side together with pupil imaging (entrance pupil being imaged onto exit pupil at optimal quality e.g. as indicated by wavefront error analysis and/or computer simulation of the system). While the examples depicted herein primarily show first order effects of telecentricity, pupil wandering and pupil distortion within the system, the present design methods may be applied more generally to optimise requirements of pupil imaging/optical systems with respect to higher order effects e.g. in terms of wavefront aberrations of the pupil imaging system formed by the objective lens arrangement. Pupil imaging performance has an impact on signal detection and noise filtering of an optical system. The extent of aberration that can be tolerated is determined by the detection physics involved in the specific system and the detection scheme used on the specimen. This may then be translated into specific tolerances for various seidel aberrations within the system such as spherical aberration, coma aberration, off-axis astigmatism, or even higher order aberrations of the pupil imaging system, which can all influence the performance of the system and preferably maintained within specific limits together with existing routine imaging requirements e.g. semiconductor wafer imaging requirements such as wafer/mask imaging wavefront, distortion, etc. These higher order effects and aberrations may be taken into account, and have been anticipated, by the design methods described herein.

Embodiments of the present technology as described above may be implemented in the manufacturing of semiconductor inspection and metrology equipment; in particular, embodiments of the present techniques may be implemented in the manufacturing or treatment process for testing, measuring and/or calibrating an optical system to improve or optimize the design of a coupling mirror used in the optical system.

Embodiments of the present technology as described above for determining a dimension of a central transmissive region of a light signal separation unit, including the determination of an axial position at which beam deformation of a light beam existing the objective lens arrangement is substantially minimal, the determination of a lateral displacement of the light beam at the axial position, calibration of an alignment of elements of the objective lens arrangement, and/or the determination of an adjustment to the dimension of a central transmissive region based on an inclination angle may all or partially be done using computer simulations or experimentally, or a combination thereof. It will be understood that the methods described herein may be implemented as a set of machine-readable instructions executable by one or more processor, e.g. in a control module or a computer.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. In particular, the present technology could also be applied to a transmission microscope. Additionally, in some implementations, the specimen is illuminated from the periphery (i.e. at an angle with the specimen surface), the central portion of the collected light then corresponds to darkfield signal, while the peripheral portion of the collected light corresponds to brightfield signal. In these implementations, the central region of said light separation unit may be reflective while a peripheral portion may be transmissive. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A method of designing an objective lens arrangement for an optical microscope system, said objective lens arrangement to be configured, in use, to collect light from a plurality of field points on an object and to onwardly transmit a light beam formed from the collected light, the method comprising:
(a) providing an objective lens;
(b) tracing, for the plurality of field points, a light cone from each field point through said objective lens arrangement;
(c) determining a marginal ray and a chief ray for said light cone from each field point exiting said objective lens arrangement and monitoring said marginal ray relative to said chief ray for each light cone exiting said objective lens arrangement;
(d) determining an exit pupil contour for said objective lens arrangement respective of each field point and monitoring an overlap of exit pupil contours respective of said plurality of field points;
(e) determining an exit pupil magnification with respect to an entrance pupil of said objective lens arrangement for each field point and monitoring a deviation in said exit pupil magnification respective of said plurality of field points;
(f) adjusting one or more physical parameters of said objective lens arrangement; and
(g) repeating one or more of (b) to (f) until said marginal ray relative to said chief ray for each light cone exiting said objective lens arrangement are substantially parallel, said overlap of exit pupil contours is substantially maximised, and said deviation in said exit pupil magnification is substantially minimised.

2. The method of claim 1, wherein said one or more physical parameters of said objective lens arrangement comprise one or more of: an addition of one or more additional optical elements, a focal length of said objective lens and/or said one or more additional optical elements, a diameter of said objective lens and/or said one or more additional optical elements, an axial distance between said objective lens and said one or more additional optical elements, or a relative lateral position between said objective lens and said one or more additional optical elements.

3. The method of claim 1 wherein said objective lens arrangement comprises at least one additional optical element, and said one or more physical parameters of said objective lens arrangement comprise an alignment of said objective lens arrangement, wherein adjusting said one or more physical parameters of said objective lens arrangement comprises adjusting a relative position of said at least one additional optical element and said objective lens.

4. The method of claim 1, further comprising determining that said marginal ray relative to said chief ray for a given light cone exiting said objective lens arrangement are substantially parallel when a relative angle between said marginal ray and said chief ray for said given light cone is less than or equal to a predetermined lower angle limit.

5. The method of claim 4, wherein said predetermined lower angle limit is 5°, 1°, 0.5°, or 0.1°, wherein 0° denotes parallel.

6. The method of claim 1, further comprising determining that said overlap of exit pupil contours is substantially maximised when said overlap of exit pupil contours respective of said plurality of field points is equal to or greater than a predetermined overlap threshold.

7. The method of claim 6, wherein said overlap of exit pupil contours respective of said plurality of field points is represented as a percentage of overlap, and said predetermined overlap threshold is 80%, 85%, 90%, 95%, 99%, 99.9%, 99.95%, wherein 100% denotes a complete overlap.

8. The method of claim 1, wherein said exit pupil magnification for each field point is a magnification of the exit pupil relative to the entrance pupil of said objective lens arrangement for that field point, and said deviation in said exit pupil magnification is a deviation from a predetermined magnification for each of said plurality of field points.

9. The method of claim 8, further comprising determining that said deviation in said exit pupil magnification is substantially minimised when a percentage of deviation from said predetermined magnification is below 5%, below 2% or below 1%, wherein, optionally, said predetermined magnification is 1.

10. The method of claim 1, further comprising configuring said objective lens arrangement such that, for each field point of said plurality of field points on said object, said onwardly transmitted light beam formed from light collected from said field point exits said objective lens arrangement as parallel light rays imageable at infinity.

11. The method of claim 1, wherein tracing, for the plurality of field points, a light cone from each field point through said objective lens arrangement comprises generating a computer simulation of said objective lens arrangement, using as inputs said one or more physical parameters of said objective lens arrangement and one or more tolerances with respect to said objective lens.

12. The method of claim 11, wherein adjusting one or more physical parameters of said objective lens arrangement comprises adjusting one or more physical parameters of said generated computer simulation of said objective lens arrangement and analysing a resulting simulation.

13. The method of claim 1, further comprising substantially simultaneously determining that said marginal ray relative to said chief ray for each light cone exiting said objective lens arrangement are substantially parallel, said overlapping is substantially maximised, and said deviation in said exit pupil magnification is substantially minimised based on wavefront error analysis.

14. A non-transitory computer-readable medium comprising machine-readable code which, when executed by a processor, causes the processor to control the design of an objective lens arrangement for an optical microscope system, said objective lens arrangement to be configured, in use, to collect light from a plurality of field points on an object and to onwardly transmit a light beam formed from the collected light, by:
(a) tracing, for the plurality of field points, a light cone from each field point through said objective lens arrangement;
(b) determining a marginal ray and a chief ray for said light cone from each field point exiting said objective lens arrangement and monitoring said marginal ray relative to said chief ray for each light cone exiting said objective lens arrangement;
(c) determining an exit pupil contour for said objective lens arrangement respective of each field point and monitoring an overlap of exit pupil contours respective of said plurality of field points;
(d) determining an exit pupil magnification with respect to an entrance pupil of said objective lens arrangement for each field point and monitoring a deviation in said exit pupil magnification respective of said plurality of field points;
(e) adjusting one or more physical parameters of said objective lens arrangement; and
(f) repeating one or more of (a) to (e) until said marginal ray relative to said chief ray for each light cone exiting said objective lens arrangement are substantially parallel, said overlap of exit pupil contours is substantially maximised, and said deviation in said exit pupil magnification is substantially minimised.

15. An objective lens arrangement for an optical microscope system, wherein the objective lens arrangement is manufactured by a process comprising:
(a) providing an objective lens;
(b) tracing, for the plurality of field points, a light cone from each field point through said objective lens arrangement;
(c) determining a marginal ray and a chief ray for said light cone from each field point exiting said objective lens arrangement and monitoring said marginal ray relative to said chief ray for each light cone exiting said objective lens arrangement;
(d) determining an exit pupil contour for said objective lens arrangement respective of each field point and monitoring an overlap of exit pupil contours respective of said plurality of field points;
(e) determining an exit pupil magnification with respect to an entrance pupil of said objective lens arrangement for each field point and monitoring a deviation in said exit pupil magnification respective of said plurality of field points;
(f) adjusting one or more physical parameters of said objective lens arrangement; and
(g) repeating one or more of (b) to (f) until said marginal ray relative to said chief ray for each light cone exiting said objective lens arrangement are substantially parallel, said overlap of exit pupil contours is substantially maximised, and said deviation in said exit pupil magnification is substantially minimised.

16. An inspection system for inspecting an object, comprising:
an objective lens arrangement manufactured by a process comprising:
(a) providing an objective lens;
(b) tracing, for the plurality of field points, a light cone from each field point through said objective lens arrangement;
(c) determining a marginal ray and a chief ray for said light cone from each field point exiting said objective lens arrangement and monitoring said marginal ray relative to said chief ray for each light cone exiting said objective lens arrangement:
(d) determining an exit pupil contour for said objective lens arrangement respective of each field point and monitoring an overlap of exit pupil contours respective of said plurality of field points;
(e) determining an exit pupil magnification with respect to an entrance pupil of said objective lens arrangement for each field point and monitoring a deviation in said exit pupil magnification respective of said plurality of field points;
(f) adjusting one or more physical parameters of said objective lens arrangement; and
(g) repeating one or more of (b) to (f) until said marginal ray relative to said chief ray for each light cone exiting said objective lens arrangement are substantially parallel, said overlap of exit pupil contours is substantially maximised, and said deviation in said exit pupil magnification is substantially minimised;
at least one imaging lens arrangement configured to receive light from said light signal separation unit to form an image; and
at least one light detector apparatus configured to detect said image formed by said at least one imaging lens arrangement.

17. The inspection system of claim 16, further comprising an illumination source arranged to illuminate said object through said objective lens arrangement by forming a focal beam at an illumination exit pupil.

18. The inspection system of claim 16, further comprising a coupling unit disposed on said imaging plane or said adjusted imaging plane, said coupling unit being configured to separate a peripheral portion of said onwardly transmitted light beam from said objective lens arrangement from a central portion of said onwardly transmitted light beam from said objective lens arrangement.

19. The inspection system of claim 18, wherein said at least one imaging lens arrangement comprises a first imaging lens arrangement configured to receive said peripheral portion of said onwardly transmitted light beam from said objective lens arrangement to form a first image, and a second imaging lens arrangement configured to receive said central portion of said onwardly transmitted light beam from said objective lens arrangement to form a second image.

20. The inspection system of claim 19, wherein said at least one light detector apparatus comprises a first light detector apparatus configured to detect said first image from said first imaging lens arrangement and a second light detector apparatus configured to detect said second image from said second imaging lens arrangement.
